(19) United States
(12) Patent Application Publication
(10) Pub. No.: US 2013/0082893 A1
(43) Pub. Date: Apr. 4, 2013

(54) CO-PHASED, DUAL POLARIZED ANTENNA ARRAY WITH BROADBAND AND WIDE SCAN CAPABILITY

(71) Applicants: Allen Wang, Fullerton, CA (US); Fangchou Yang, Los Angeles, CA (US); Hee Kyung Kim, El Segundo, CA (US)

(72) Inventors: Allen Wang, Fullerton, CA (US); Fangchou Yang, Los Angeles, CA (US); Hee Kyung Kim, El Segundo, CA (US)

(73) Assignee: RAYTHEON COMPANY, Waltham, MA (US)

(21) Appl. No.: 13/249,491

(22) Filed: Sep. 30, 2011

(51) Int. Cl. H01Q 21/24

(52) U.S. Cl. 343/810; 343/848

(57) ABSTRACT

Provided herein are devices, systems and techniques for establishing a coincident-phased dual polarization array aperture enabling a wide scan capability, while also presenting a bandwidth of at least about 40%. Radiating elements of such an array include a first ground plane extending between lower and upper edges and a first radiating element positioned above the upper edge of the first ground plane. The array elements also include a second ground plane extending between respective lower and upper edges and disposed substantially orthogonal to the first ground plane. A second radiating element is positioned above the upper edge of the second ground plane, such that the first and second radiating elements have different polarizations.

Parallel ground planes of adjacent antenna elements of an array of like elements enhance array performance by providing isolation between such radiating elements and backplane ground by way of a phenomenon generally known as waveguide-below-cutoff.

Various embodiments are described herein relating generally to the field of antennas, and more particularly to conformal antenna arrays.

### BACKGROUND

Many of today's sensors require coincident-phased dual polarization aperture with a wide scan capability (e.g., 60 degrees conical scan) and a relatively wide operational bandwidth (e.g., about 40%). Preferably the design should be low-loss and of a simple construction.

Some attempted solutions for satisfying such operational requirements are based on microstrip patch radiators. Although such structures generally represent simple constructions, such radiators are inherently narrowband. Additionally, dual polarization operation of such structures would generally result in at least some degree of phase offset due to the slight positional difference of the dual radiating structures.

Other approaches include more complicated radiating structures, such as quad-notch radiators. These structures, however generally require complex construction and combination with aspects that introduce undesirable signal loss. Still other approaches include “thumbtack” style radiating elements. Once again, such constructions are simplistic, but typically require a balun that necessarily introduces a signal loss.

Although such lossy components may improve some performance parameters, such as operational bandwidth, they generally limit performance in other important areas. The introduction of such losses reduces operational sensitivity, with undesirable impacts to weak signals in receive mode operation. Additionally, the introduction of such lossy components can further contribute to unwanted reduction in emissions during transmission mode operations.

Additionally, there is a need for lightweight, structural panel arrays in sensor platforms, such as the AWACS, Predator, and other unmanned air vehicles. Many such aerospace applications require that the antenna be built onto the skin of the sensor platform, thereby requiring an exposed surface, or face, of the antenna aperture to be conformal or curved. Such conformal panel arrays require variable height radiating aperture since the backside electronic panels are typically planar. Also, as structural members, such arrays require load-bearing apertures.

### SUMMARY

Described herein are embodiments of systems and techniques for developing a coincident-phased dual polarization array aperture enabling a wide scan capability, while also presenting a bandwidth of at least about 40%. This aperture interleaves center-fed dipoles, each with its own vertical ground planes, and makes use of the waveguide below cutoff properties of overlapping portions of adjacent vertical ground planes. As the operating frequency approaches the cutoff frequency, the effective ground plane height that the radiator sees changes. This property helps match and broaden the bandwidth of a dipole array, which is generally no more than 20% BW. The waveguide cutoff properties also improve the radiating elements scan range. The interleaved dipole arrangement makes the co-phase requirement possible.

In one aspect, at least one embodiment described herein provides an antenna array including a first ground plane that extends between lower and upper edges. A first antenna is positioned above the upper edge of the first ground plane. The antenna array also includes a second ground plane extending between respective lower and upper edges. The second ground plane is disposed substantially parallel to the first ground plane, such that the first and second ground planes define an overlapping region. The ground planes are spaced apart by a separation distance. A second antenna is positioned above the upper edge of the second ground plane. The arrangement of first and second ground planes rejects electromagnetic coupling into the overlapping area of the first and second ground planes. In some embodiments, the separation distance is less than about one-half a shortest anticipated wavelength of operation. Without restriction, the first and second antennas can be a dipole antenna.

In some embodiments, each of the first and second dipole antennas can be defined by a conducting region disposed on an insulating substrate. Each respective one of the first and second ground planes can also be defined by a conducting region on the insulating substrate. In some embodiments, the substrate includes a structural support, for example, serving as a structural support upon which the antenna array is mounted.

In some embodiments, the antenna array further includes a reference ground plane in electrical contact with the respective lower edge of each of the first and second ground planes. For example, the reference ground plane can be positioned perpendicular to each of the first and second ground planes. Each antenna can be configured with a respective transmission line, for example, extending between a feed point of a respective one of the first and second dipole antennas and a respective dipole antenna interface port (driving point). In at least some embodiments, the transmission lines can be disposed along an opposite side of the reference ground plane.

In some embodiments, the antenna array further includes a third ground plane extending between lower and upper edges. The third ground plane intersects each of the first and second ground planes at an intersection angle (e.g., 90 degrees). A third antenna is disposed at a height above the upper edge of the third ground plane. The third antenna can have a different polarization than either of the first and second antennas (e.g., crossed dipole).

In some embodiments, each of the first, second, and third antennas is defined by a respective conducting region on a respective insulating substrate. Likewise, each respective one of the first, second and third ground planes is also defined by a conducting region on a respective one of the insulating substrates. In some embodiments, a reference ground plane is provided in electrical contact with the respective lower edge of each of the first, second and third ground planes. The reference ground plane can be positioned perpendicular to each of the first, second and third ground planes.

In another aspect, at least one embodiment described herein relates to an antenna array element including a first ground plane extending between lower and upper edges and a first radiating element positioned above the upper edge of the first ground plane. The first radiating element has a respective phase center and a first associated polarization. The antenna array element also includes a second ground plane also extending between respective lower and upper edges. The second ground plane is disposed substantially orthogonal to the first ground plane. A second radiating element is positioned above the upper edge of the second ground plane, having a second respective phase center and second associated polarization different from the first. The first and second respective phase centers are coincident.

In some embodiments, the antenna array element further includes an electrically conducting backplane abutting bottom edges of the first and second ground planes. Beneficially, the backplane can be substantially isolated from the first and second radiating elements when configured in rectangular grid array of similar array elements, by way of parallel ground planes providing waveguide-below-cutoff isolation.

In some embodiments, the radiating elements are dipole antennas. Such dipole antenna elements of an array element can be arranged to provide a polarization angle between dipole antenna elements that is substantially 90 degrees.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a schematic representation of an embodiment of an antenna array.

FIG. 2A shows a schematic representation of another embodiment of an antenna array.

FIG. 2B shows a schematic representation of yet another embodiment of an antenna array.

FIG. 3A and FIG. 3B show top and side cross-sectional views of an embodiment of an antenna element.

FIG. 4A and FIG. 4B show top and side cross-sectional views of another embodiment of an antenna element.

FIG. 5A and 5B respectively show a perspective view and a side view of an embodiment of a crossed dipole antenna assembly.

FIG. 6 shows a top schematic view of the crossed dipole antenna assembly shown in FIG. 5A and FIG. 5B.

FIG. 7 shows an exploded perspective view of an embodiment of an antenna assembly including a conformal antenna array.

FIG. 8 shows a schematic planar view of a linear polarized antenna array.

FIG. 9 shows a schematic planar view of a dual-polarized antenna array.

FIG. 10 shows a graphical representation of return loss versus frequency of an embodiment of an antenna array constructed according to the techniques described herein for various pointing angles on the E-plane.

FIG. 11 shows a graphical representation of return loss versus frequency of the same embodiment of an antenna array constructed according to the techniques described herein for various pointing angles on the H-plane.

FIG. 12 shows a graphical representation of return loss versus frequency of the same embodiment of an antenna array constructed according to the techniques described herein for various pointing angles on the diagonal plane.

FIG. 13 shows a graphical representation of crossed-polarization isolation for various frequencies and scan angles for an embodiment of a dual polarization antenna array constructed according to the techniques described herein at various pointing angles on the E or H plane.

FIG. 14 shows a graphical representation of crossed-polarization isolation for various frequencies and scan angles for an embodiment of a dual-polarization antenna array constructed according to the techniques described herein at various pointing angles on the diagonal plane.

### DETAILED DESCRIPTION

Described herein are embodiments of radiating structures positioned above edges of ground planes. The ground planes are positionable in at least partially overlapping arrangements to form arrays of such radiating structures. In at least some embodiments, the ground planes are substantially parallel and the corresponding edges are substantially aligned. Such arrangements discourage electromagnetic coupling into structures positioned between the overlapping ground planes for frequencies below a cutoff frequency. Such isolation is to at least some degree dependent upon perpendicular separation between the parallel ground planes and frequency, or wavelength, of the electromagnetic radiation. The phenomenon responsible for the isolation of such a configuration is generally known as waveguide-below-cutoff, in which propagating modes of time-varying electromagnetic fields (e.g., TE₀₁) are substantially allowed or otherwise supported between the ground planes for frequencies above a cutoff frequency (wavelengths below a cutoff wavelength) and substantially blocked for frequencies below the cutoff frequency (wavelengths above the cutoff wavelength). The cutoff wavelength λ_{c} can be determined from the separation distance S from the expression: λ_{c}=2 S. Likewise, the cutoff frequency f_{c} can be determined from the expression: f_{c}=c/(2 S)=c/λ_{c}, where c is the speed of light.

Examples of such radiating elements include broadside and end-fire radiating elements, such as dipoles and flared notches. The same radiating elements can be repeated across an antenna array aperture, the spacing between radiating apertures referred to as lattice spacing. In some embodiments, the radiating elements are dual-polarized elements, such as crossed dipoles. Such dual-polarized elements are capable of supporting independent linear polarizations, or a selective polarization determined as some combination of the two (e.g., diagonal or slant polarization). When combined with a phase offset between the dual-polarized elements of each individual radiating element, the dual polarized elements are capable of supporting elliptical polarization, such as right-hand circular polarization and left-hand circular polarization.

Antenna structures having radiating elements positioned above edges of a parallel arrangements of ground planes can be further positioned above a common reference ground plane, or backplane. Considering the backplane as a being horizontal, the parallel overlapping ground planes can be substantially vertical, for example, being orthogonal to the backplane in an arrangement generally referred to as an “egg crate” configuration. Beneficially, the waveguide below cutoff phenomena described herein isolates the radiating elements positioned above the vertical ground plane edges from the backplane. Such decoupling offers performance advantages, for example allowing lower backplane effect and thus growth to wider bandwidth applications (e.g., greater than 40 percent operating bandwidth) than existing designs.

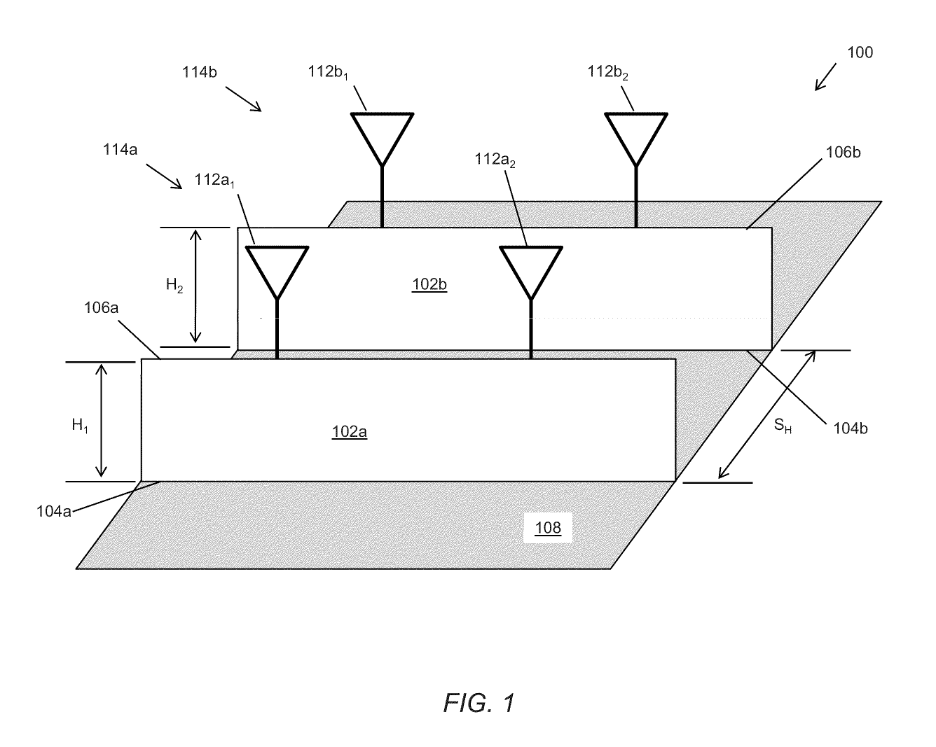

A schematic representation of an embodiment of an antenna array is shown in FIG. 1. The illustrative antenna array 100 includes a first ground plane 102a extending for a height H₁ between a lower edge 104a and an upper edge 106a. Also shown is a second ground plane 102b similarly extending for a height H₂ between a lower edge 104b and an upper edge 106b. The two ground planes 102a, 102b (generally 102) are positioned in at least partially overlapping, parallel arrangement, being separated by a minimum separation distance S_{H}. The ground planes 102 are positioned above a common horizontal ground plane, or backplane 108. In the illustrative embodiment, the lower edges 104a, 104b (generally 104) are in electrical contact with the backplane 108, for example resting upon a surface of the backplane 108, as shown. Additionally, although not necessarily a requirement, the upper edges 106a, 106b (generally 106) are parallel, residing in the same plane for H₁=H₂.

A first sub-array 114a containing two radiating elements 112a₁, 112a₂ is positioned above the upper edge 106a of the first ground plane 102a. Likewise, a second sub-array 114b of two radiating elements 112b₁, 112b₂ is positioned above the upper edge 106b of the second ground plane 102b. Each of the first and second sub-arrays 114a, 114b (generally 114) can include a greater or fewer number of radiating elements 112.

An overlapping area is formed between the parallel arrangement of the ground planes 102, defined at least between the respective upper edges 106 and lower edges 104. A plane containing the upper edges 106 of the vertical ground planes 102 can be considered as a virtual ground plane. In operation, at least a portion of radiated electromagnetic energy from the antenna elements 112 is directed toward the backplane 108. Without the benefits provided by the virtual ground boundary of the upper edges 106, such energy would otherwise reflect from the backplane 108 (inducing ground currents) and interact with radiated energy from the radiating element 112 and perhaps other radiating elements 112 in a manner dependent upon the spacing of the radiating elements above the backplane 108. By the nature of the vertical conducting ground planes 102, however, the waveguide-below-cutoff phenomenon can result in dramatic reduction if not elimination of electromagnetic interaction between the antenna elements 112 and the backplane 108.

Conceptually, the two vertical ground planes 102 can be considered to form a parallel plate waveguide. Electromagnetic energy directed from the antenna elements 112 toward a parallel plate waveguide opening formed by the upper edges 106 of each of the vertical ground planes 102 in the illustrative example can give rise to propagating waveguide modes within the waveguide, depending upon the wavelength of the radiation and the separation of the walls of the waveguide (i.e., separation S_{H} between the vertical ground planes 102). Preferably, separation S_{H} between adjacent vertical planes 102 can be selected to establish a cutoff frequency f_{c}, thereby isolating the radiating elements 112 from the backplane 108 over a desired range of frequencies of operation. The ground “trough” created by adjacent elements acts like a cutoff waveguide. The backward traveling energy never reaches the horizontal ground plane if the ground trough is greater than a preferred separation distance. The preferred separation distance can be selected to provide an optimal performance in a desired band. For example, in some embodiments, the preferred separation distance can be less than about S. In other embodiments, the separation distance can be less than about S/2. The selection would also depend on the available real estate.

The “waveguide below cutoff” effect is relied upon to selectively isolate the backplane 108 from the antenna elements 112 at frequencies below cutoff f_{c}. A minimum height, or spacing above the backplane 108 for any of the embodiments described herein, should be chosen such that energy otherwise blocked by the waveguide-below-cutoff effect will be damped sufficiently (backward impedance sufficiently high) to realize a desired benefit. In at least some embodiments, spacing of antenna elements 112 above the ground plane 108 (i.e., H₁, H₂) is greater than a minimum height of about one eighth of a wavelength (i.e., λ/8) for about 40% bandwidth. Greater minimum heights (e.g., λ/4, λ/2) can be selected, for example, when incorporated into non-planar platforms.

It is important to note, that although the radiating elements are described in the illustrative embodiments as radiating electromagnetic energy (i.e., transmitting mode), such radiating elements are equally capable of receiving electromagnetic energy (i.e., receiving mode). Through the well-established duality principal of antenna structures, the performance advantages described in the context of radiating mode, apply similarly to both transmitting and receiving modes.

The radiating elements can be relative simple structures, such as monopoles, dipoles, loops, patches, horns, notches, apertures, flared notches. Alternatively or in addition, the radiating elements can be more complex structures, for example designed for greater directivity and or greater frequency band of operation, such as Yagi Uda arrays, log-periodic arrays, spirals, such as log-periodic spirals. The antenna elements can be formed of electrically conducting structures, such as wires, conducting surfaces, slots in conducting surfaces, and waveguide structures.

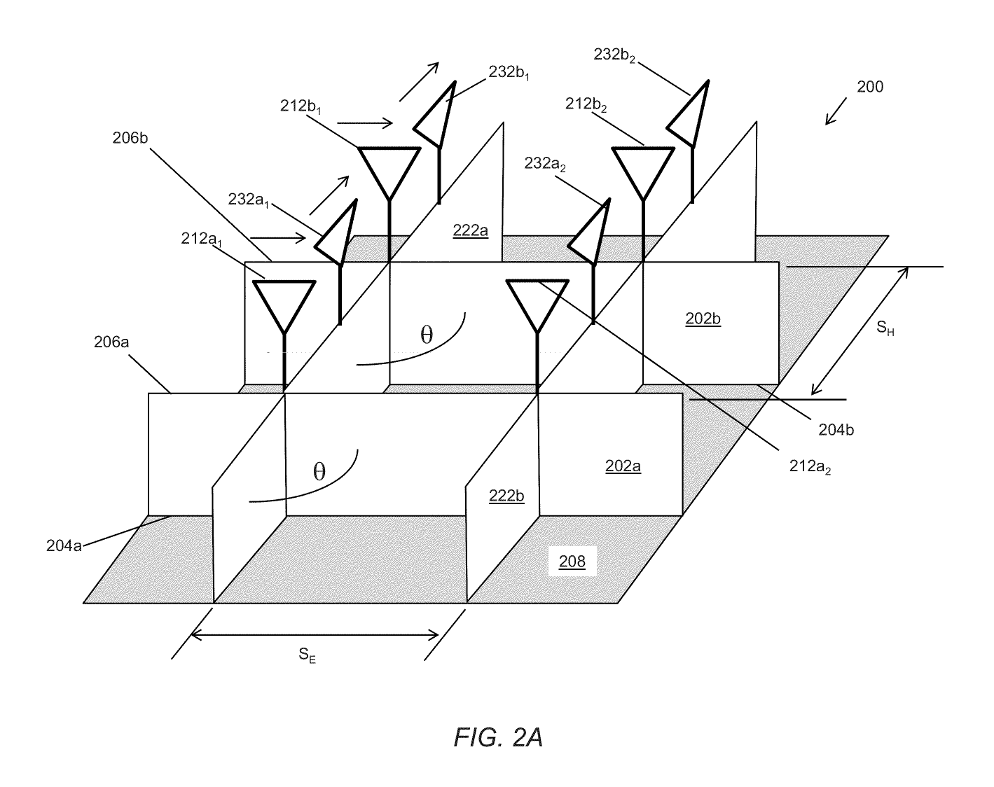

A schematic representation of another embodiment of an antenna array is shown in FIG. 2A. The array 200 includes at least two vertical ground planes 202a, 202b (generally 202), each extending between respective lower and upper edges 204a, 204b, 206a, 206b. In the illustrative embodiment, each of the first and second ground planes 202 is disposed perpendicularly above a common horizontal ground plane or backplane 208. The array 200 also includes at least a third ground plane, the illustrative embodiment providing two such ground planes 222a, 222b (generally 222) extending along a second different common direction. An angle of intersection θ is formed by intersection of the two parallel groups of vertical ground planes 202, 222. In at least some embodiments, the angle of intersection is approximately 90 degrees. Such structures forming a regular rectangular grid form egg-crate style antenna arrays.

Disposed above the first and second vertical ground planes 202 are a respective number of antenna elements 212a₁, 212a₂, 212b₁, 212b₂ (generally 212). The antenna elements 212 can be located at the intersection of the vertical planes 202, 222, as shown, or along the respective vertical ground planes 202 between such intersections. Disposed above the third and fourth vertical ground planes 222 are a respective number of antenna elements 232a₁, 232a₂, 232b₁, 232b₂ (generally 232). The antenna elements 232 can be located at the intersection of the vertical planes 202, 222, or along the respective third and fourth vertical ground planes 222 between such intersections, as shown.

Polarizations of the antenna elements 212, 232 can be identical or vary, for example, according to their respective ground plane 202, 222. For example, in the illustrative embodiment, the polarization of the antenna elements 212 above the first and second ground planes 202 is linear, being substantially aligned with the edge of the respective ground plane 202. The polarization of the antenna elements 232 above the third and fourth ground planes 222 is also linear, however, being substantially aligned with the edge of the respective ground planes 222 (i.e., varying by θ degrees from each other).

When antenna elements above each of the groups of vertical ground planes are formed at the intersections, the antenna elements can be formed as “crossed-polarized” elements, such as crossed dipoles. An example of such an embodiment of an array 250 is shown in FIG. 2B. In this embodiments, the array 250 a first pair of parallel overlapping vertical ground planes 252a, 252b (generally 252) and a second pair of parallel overlapping vertical ground planes 272a, 272b (generally 272) are disposed with respect to each other at an angle of θ=90 degrees. The vertical ground planes 252, 272 are disposed above a common conducting backplane 258. Four compound antenna elements 262a₁, 262a₂, 262b₁, 262b₂ (generally 262) are disposed at the four intersections of the two sets of parallel ground planes 252, 272. The compound antenna elements are cross-polarized structures, such as, for example, crossed horizontal dipole antennas.

With crossed elements 262, such as crossed horizontal dipole radiators, it is possible to provide a first linear polarization with a second independent perpendicular linear polarization, a linear slant polarization as some combination of the two linear polarizations, and elliptical polarizations, such as right-hand circular polarization and left-hand circular polarization. Of course, circular polarization require an appropriate feed network providing a phase offset (e.g., +/−90 degrees) between each portion of the crossed element 262. It is understood that the antenna array structures described herein can be combined with well-established antenna array principles, including signal routing elements, such as corporate feed networks, phase offset elements, such as delay lines, and variable phase delays, filters, amplifiers and the like. Such signal routing elements (not shown) can be provided along an opposite side of the backplane 258 from the radiating elements.

In some embodiments, one or more of the ground planes 102, 202, 222, 252, 272, 108, 208, 258 can be formed from rigid metals, such as sheet metals or castings. Alternatively or in addition, one or more of the ground planes 102, 202, 222, 252, 272, 108, 208, 258 can be formed from layered structures, such as metals layered on a substrate. Some examples include printed circuit board type structures, and the like. Other structures include metal coated insulators, such as a rigid polymer (e.g., plastic) coated with a conductive layer. Such polymer substrates can be formed from any suitable known technique, such as blow molding, casting, and the like. Conductive coatings can be applied according to any of a number of known techniques, such as painting, dipping, laminating, electroplating, sputtering, thin film deposition, and the like. When serving as structural members, selection of substrate material and/or thickness can be taken into consideration in view of anticipated loading requirements.

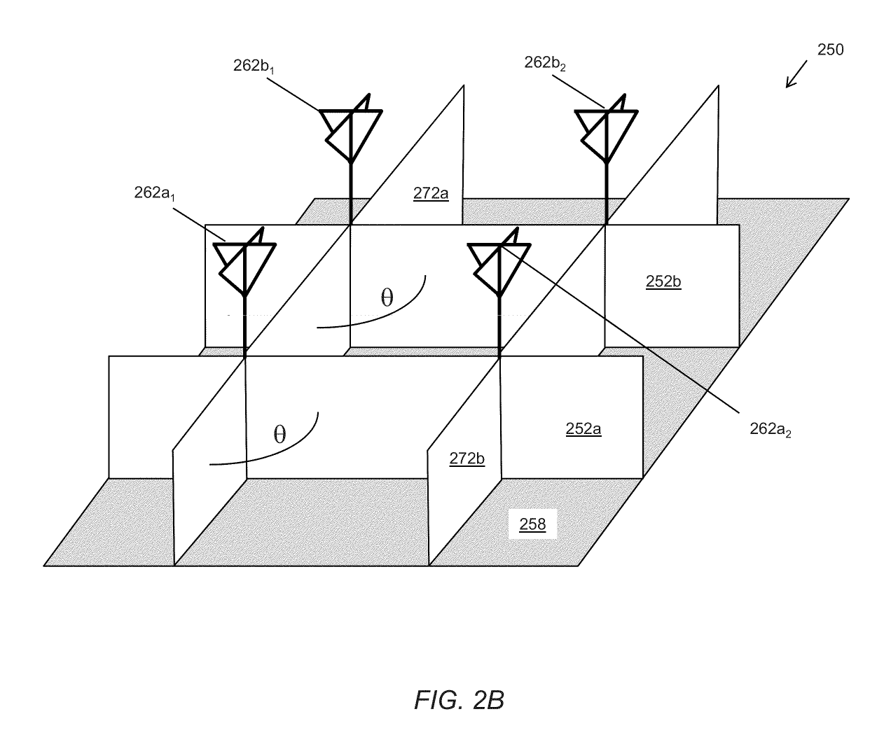

A planar view of a portion of an embodiment of antenna radiating element assembly is shown in FIG. 3A. The radiating element assembly 300 includes a first ground plane 302 having a lower edge 304 and an upper edge 306. A dipole antenna 312 is disposed above the upper edge 306. In the illustrative example, the dipole antenna 312 is arranged parallel to and set apart from the upper edge 306. A transmission line 310 extends from a driving point 314 of the dipole antenna 312 down towards the lower edge 304. In the illustrative example, the transmission line 310 is a parallel line structure, with a lower portion being disposed above the ground plane 302. Accordingly, the lower portion of the transmission line 310 is generally understood to be balanced.

The dipole antenna 312 includes a left-hand radiating element 314a and a right hand radiating element 314b, each collinear and arranged parallel to the upper edge 306. In the illustrative embodiment, the dipole element 312 is formed from an electrically conducting layer 320 disposed on an insulating substrate 322, as also shown in FIG. 3B. Lending to simplicity, the transmission line 310 can also be formed by the same electrically conducting layer 320. The ground plane 302 is formed along an opposite side of the generally planer substrate 322, separating it from the transmission line 310 and dipole antenna 312. It is conceivable that the general structure of a radiating element disposed relative to the upper edge 306 of an underlying vertical ground plane 302 can be fashioned from a multitude of other variations according to techniques generally well understood in antenna design.

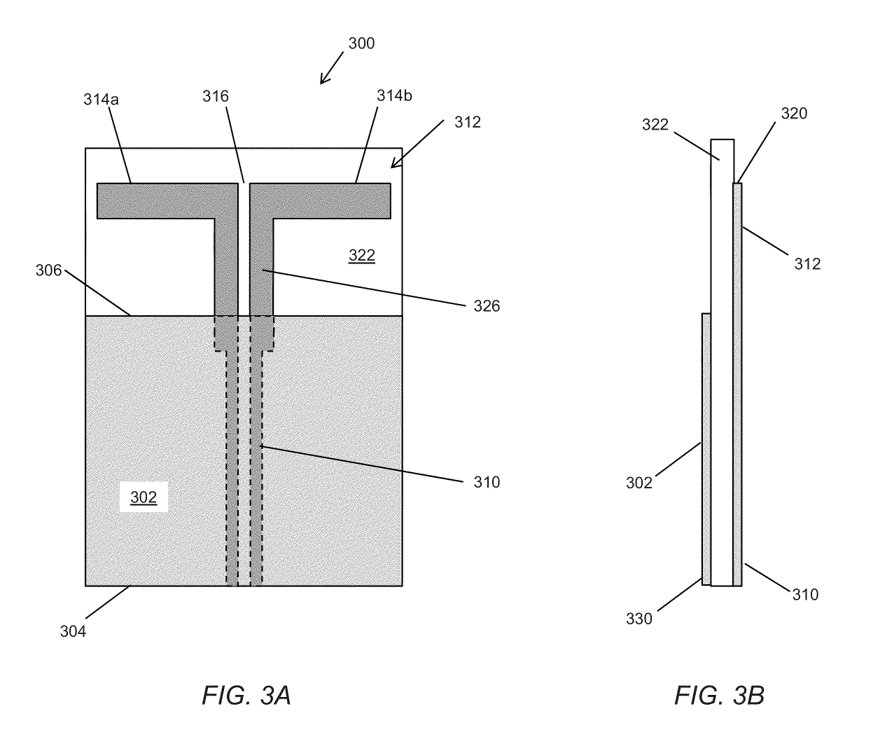

Another embodiment of a radiating element assembly 350 is shown in FIG. 4A. The radiating element assembly 350 includes a first ground plane section 352a having a lower edge 354a and an upper edge 356a and an overlapping second ground plane section 352b, also having a lower edge 354b and upper edge 356b. A dipole antenna 362 is disposed above the upper edges 306a, 306b (generally 306). A transmission line 360 extends from the dipole antenna 362 down towards the lower edges 354a, 354b (generally 354). In the illustrative example, the transmission line 360 is also parallel line structure, with a lower portion being disposed between the ground plane sections 352. Accordingly, the lower portion of the transmission line 360 is generally understood to represent a parallel stripline configuration. A cross section of the sub-array is shown in FIG. 4B, in which the dipole antenna 362 and transmission line 360 are formed from a common electrically conducting layer 371 embedded within the insulating substrate 372. The two ground plane sections 352 are formed on either side of a portion of the insulating layer 372.

The ground plane sections 352, with respect to radiation performance of the dipole antenna, essentially behave as a single common electrical ground. In order to enhance such performance as a common ground, one or more short circuits 380 are introduced between each overlapping section of the ground plane 352. The short circuits can be implemented with shorting wires, plated through holes, or any such suitable structure.

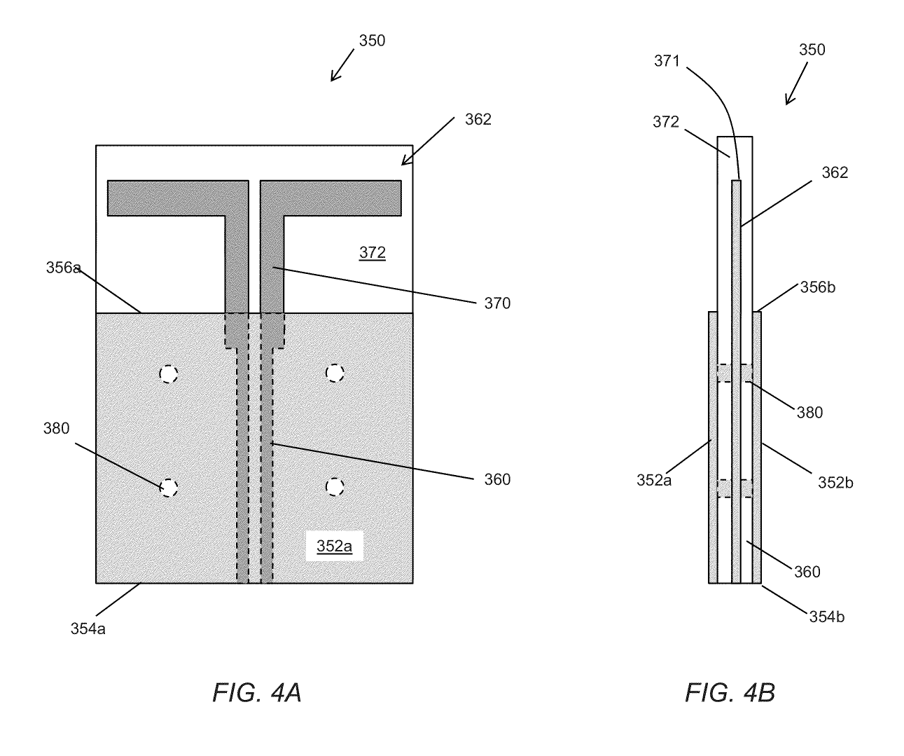

A perspective view of an embodiment of a cross-polarized radiating element assembly 400 usable in any of the antenna arrays described herein is shown in FIG. 5A and FIG. 5B. The cross-polarized radiating element assembly 400 includes a first dipole antenna sub-assembly 402a, including a dipole antenna 404a and a ground plane 406a defining an upper edge 408a. The dipole antenna 404a and the ground plane 406a reside within parallel planes, with the dipole antenna 404a being substantially parallel to and spaced apart from the upper edge 408a. A transmission line 410a is provided for electromagnetically coupling to the dipole antenna 404a. The transmission line 410a extends away perpendicularly from a central region of the dipole antenna 404a and beyond the upper edge 408a and toward a lower edge 412a of the ground plane.

In the illustrative example, the ground plane 406a includes a non-conductive opening, such as a channel 414a. In the illustrative embodiment, the open channel 414a extends along a centerline, perpendicularly away from a central region of the dipole antenna element 404a and within the plane of the ground plane 406a. The open channel 414a is further defined by lateral edges 416a of the ground plane segment 406a. A plane containing the dipole antenna element 404a is separated from the ground plane 406a by an intermediate insulating (e.g., dielectric) layer. In at least some embodiments, another ground plane 406a′ is provided in overlapping arrangement with the original ground plane 406. For example, the other ground plane 406a′ is similarly separated from the plane containing the dipole antenna element 404a by another insulating layer, essentially sandwiching a conducting plane 450a containing the dipole element 404a between the ground planes 406a, 406a′.

One or more short circuits 409 can be provided for electrically interconnecting overlapping portions of the ground planes 406a, 406a.′ For example, at least two short circuits 409 can be provided in each portion of the ground plane 406 separated by the open channel 414a. One of the short circuits 409 can be disposed towards an upper edge 408a, and the other 409 toward the lower edge 412a. Greater or fewer numbers of short circuits 409 are contemplated. The short circuits 409 can be provided by electrically conducting wires, plated through holes or vias, or any other suitable means for electrically interconnecting the ground planes 406a, 406a′. The short circuits 409 should be implemented sufficiently in number and location to avoid the generation of undesirable parallel-plate modes.

The cross-polarized radiating element assembly 400 includes a second dipole antenna sub-assembly 402b, including a dipole antenna 404b and ground planes 406b, 406b′ defining an upper edge 408b. The second dipole antenna sub-assembly 402b can be essentially the same as the first 402a, although it is conceivable that the two dipole sub-assemblies might differ. The two sub-assemblies 402a, 402b are joined at right angles along their common centerlines. In at least some embodiments, the upper edges 408a, 408b reside in a common plane.

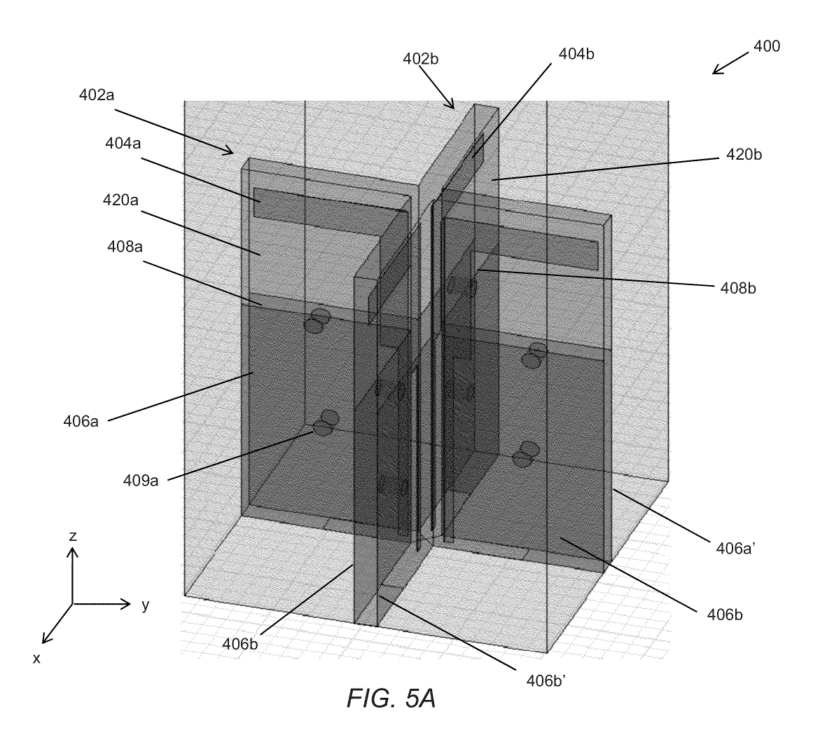

Referring to FIG. 6, a schematic representation is shown of a top view of the cross-polarized radiating element assembly 400. In particular, the antenna element 404a is formed by conducting surface layer 450a embedded with the substrate 420a. The ground plane 460a is also shown along one side of the vertical substrate 420, and the other ground plane 460a′ shown along another side of the vertical substrate 420. The transmission line 410 is also defined within the conducting plane containing the dipole antenna element 404a. The open central region 414a allows for uninterrupted intersection with the cross-polarized antenna element assembly 402b, without adverse impact to operation of either the dipole 404a or the transmission line 410a.

Likewise, the second antenna element 404b is formed by conducting surface layer 450b embedded with the substrate 420b. The ground plane 460b is also shown along one side of the vertical substrate 420b, and the other ground plane 460b shown along another side of the vertical substrate 420b. The transmission line 410b is also defined within the conducting plane containing the dipole antenna element 404b. The open central region 414b allows for uninterrupted intersection with the cross-polarized antenna element assembly 402a.

In at least some embodiments, one or more of the supporting substrates 420a, 420b can be structural elements. For example, one or more of the substrates 420a, 420b can include cyanate ester quartz (CEQ). In at least some embodiments, CEQ at thicknesses of about 50 mils can be used for a backplane 258 (FIG. 2B), and at a thickness of about 25 mils for the vertical 420a, 420b, for an array having radiator heights of about 0.5 inches.

Beneficially, operation of the individual antenna elements (e.g., dipoles 402a, 402b) of a cross-polarized radiating element assembly (e.g., assembly 400) can be configured for coincident phase operation. Such operation is due at least in part to the high degree of symmetry provided by the design. In at least some embodiments, antenna array elements having different polarizations are integrated along a common centerline, such as the crossed dipole structures described herein. Accordingly, the radiation performance of each element of such a crossed pair is determined according to a common phase center. Such a phase center can be achieved first by the driving point of the exemplary dipole antennas, which overlap at a common point. Additionally, continued symmetry of the transmission line structure feeding each element of a crossed pair, preserves such coincident phase performance at an input to the transmission line feed structure.

It is further contemplated that a radome (not shown) could be combined with any of the antennas or antenna array structures described herein. For example, a radome can be disposed above an antenna array back plane, effectively sandwiching the antenna array elements between the radome and the backplane. It is also conceivable that such a radome can be formed upon the antenna array elements using standard radome construction techniques and relying on the antenna elements to provide structural support for the radome. Examples of such radomes include thicknesses of 17.6 mils and 35.2 mils, for example, fabricated from CEQ.

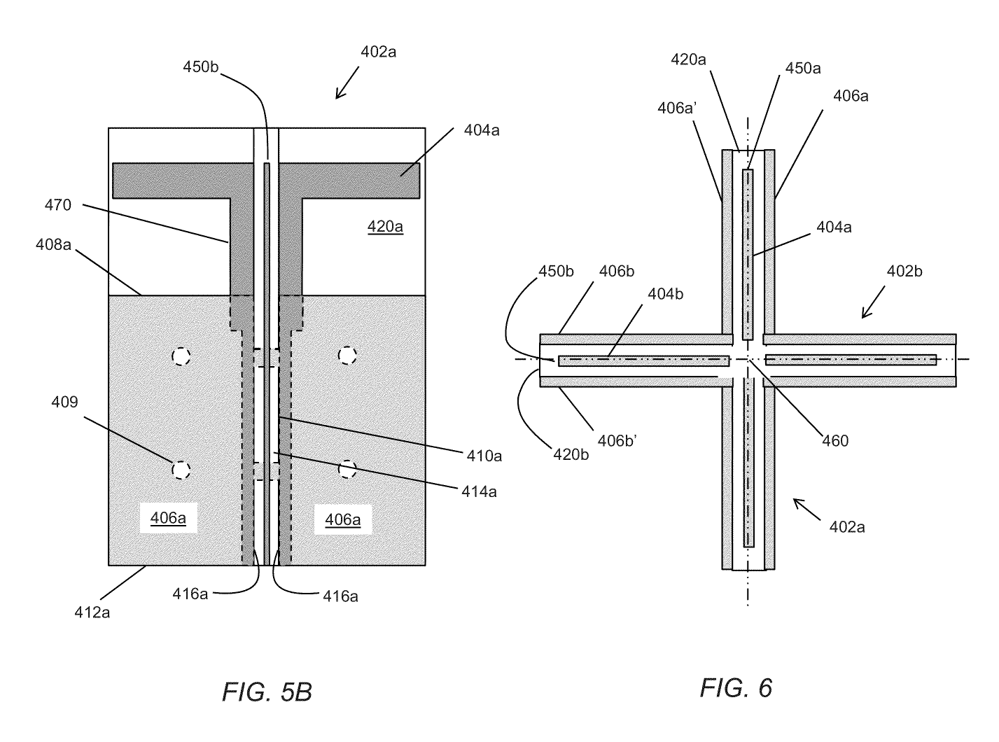

The antenna arrays 100, 200, 250 described thus far are generally part of a larger antenna array assembly. An exploded perspective view of an embodiment of such an antenna assembly including a conformal antenna array 500 is shown in FIG. 7. The assembly 500 includes an antenna module 502, and electronics module 504, and an interface module 506. In the illustrative example, the antenna module 502 includes an egg crate array of radiating elements 508 arranged according to the techniques described herein. Namely, the antenna module 502 includes antenna elements 508 forming a conformal or otherwise curved array surface 503 disposed above a common planar backplane. A horizontal ground plane is formed along the backplane, under each antenna element of the array. In the illustrative embodiment, the antenna assembly 502 also includes an RF interface board 510 disposed along the backplane. In particular, the RF interface board 510 is located on an opposite of the horizontal ground plane and thereby at least partially shielded from radiation of the antenna elements 508.

The electronics module 504 includes electronic assemblies and/or components as may be necessary for operation of the antenna array assembly 500. For example, the electronics module 504 typically includes an RF distribution network configured to selectively interconnect one or more of the antenna elements to one or more of a transmitter and a receiver. The RF distribution network may include one or more of transmission lines, RF couplers, switches, amplifiers, filters, attenuators, fixed phase offsets, such as delay lines, variable phase offsets, power supplies and control elements. In at least some embodiments, the control elements, in combination with other components of the electronics module, are adjusted to configure the antenna array assembly as a steerable phased array according to generally well known techniques. In at least some embodiments, one or more of the electronics module, the interface module and the antenna module are configured to provide thermal management. Such thermal management can be accomplished, for example, by one or more of heat sinks and active coolers. Such active cooling can include one or more of forced cooling air, circulating cooling fluid, and thermoelectric coolers.

In at least some embodiments, the antenna assembly 500 includes an interface module 506. For example, the interface module 506 can include a spring pin adapter plate to facilitate interconnection between the RF interface board 510 and the electronics module 504.

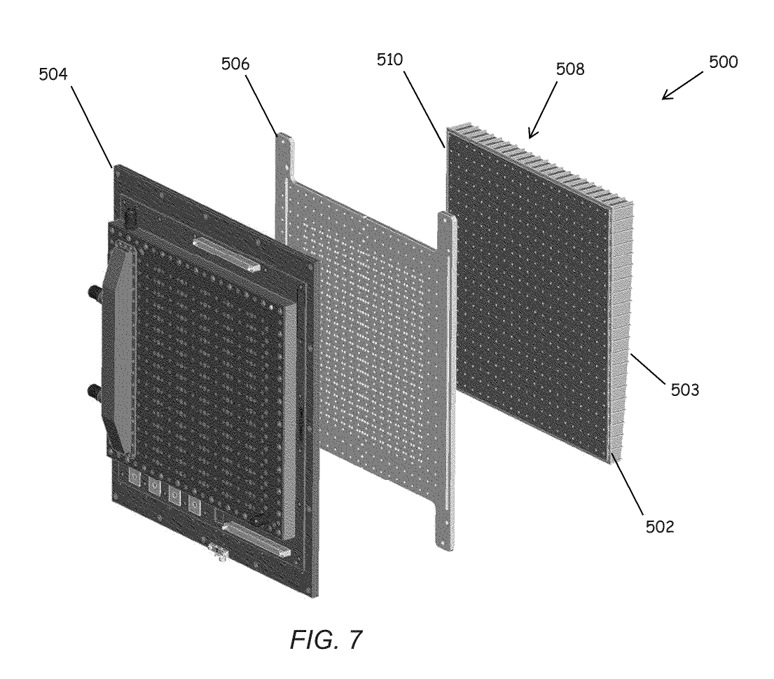

FIG. 8 shows a schematic representation of a portion of an embodiment of a linearly polarized antenna array 600. In particular, four elongated antenna elements 602a₁, 602a₂, 602b₁, 602b₂ (generally 602) are shown spaced apart on a rectangular grid. The antennas 602 are elongated along an E-plane, for example, representing dipole antennas. A first pair of aligned antenna elements 602a₁, 602a₂ is spaced apart from a second pair of aligned elements 602b₁, 602b by an H-plane separation distance S_{H}. Each antenna element of the aligned pairs is separated from the other by an E-plane separation distance S_{E}.

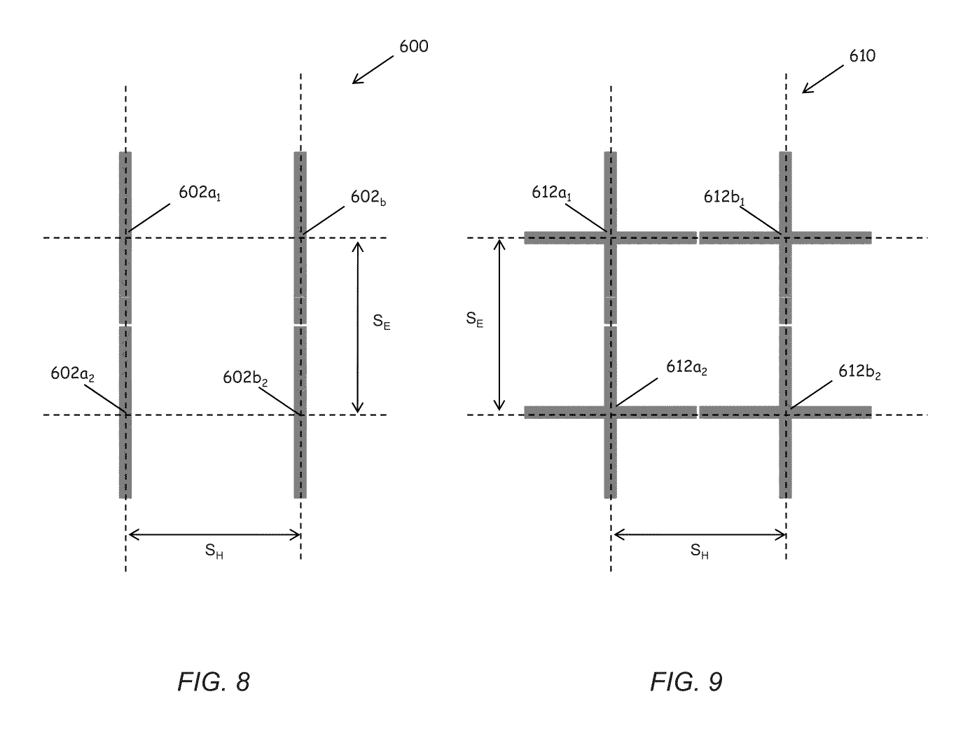

FIG. 9 shows a schematic representation of a portion of an embodiment of a crossed-polarized antenna array 610. In particular, four cross-polarized antenna elements 612a₁, 612a₂, 612b₁, 612b₂ (generally 612) are shown spaced apart on a rectangular grid. The antennas 612 can included any suitable cross-polarized structure, such as dipole antennas, loops, notches, flared notches, horns, and the like. A first pair of aligned antenna elements 612a₁, 612a₂ is spaced apart from a second pair of aligned elements 612b₁, 612b by a separation distance S_{H}. Each antenna element of the aligned pairs is separated from the other by a separation distance S_{E}. Although rectangular arrangements or lattices of radiating elements have been shown for illustrative purposes, it is contemplated that other lattice arrangements are possible, such as triangular, hexagonal and the like.

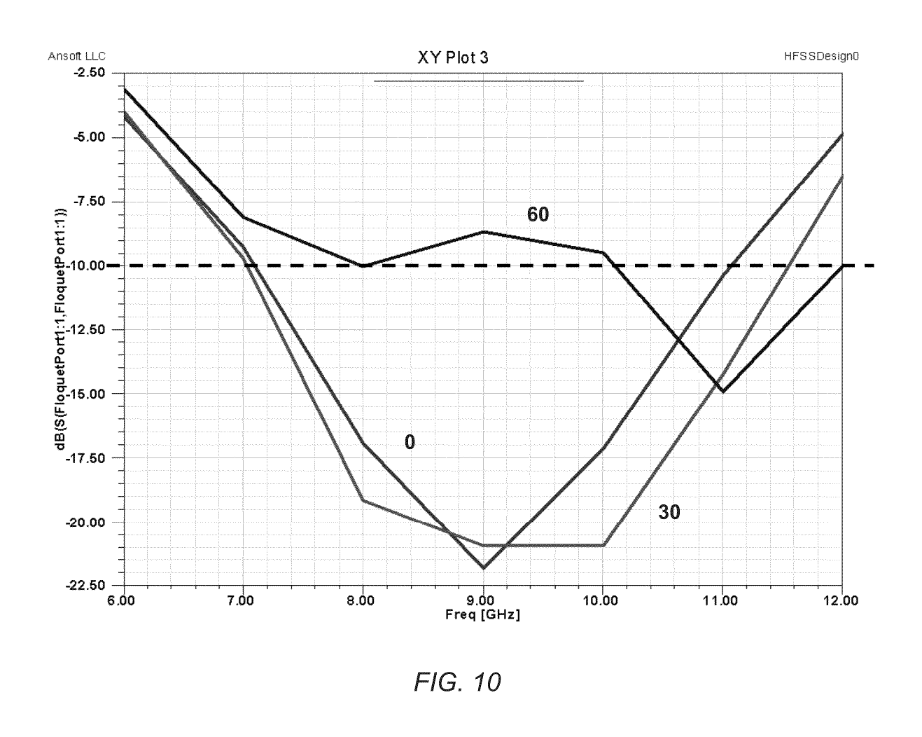

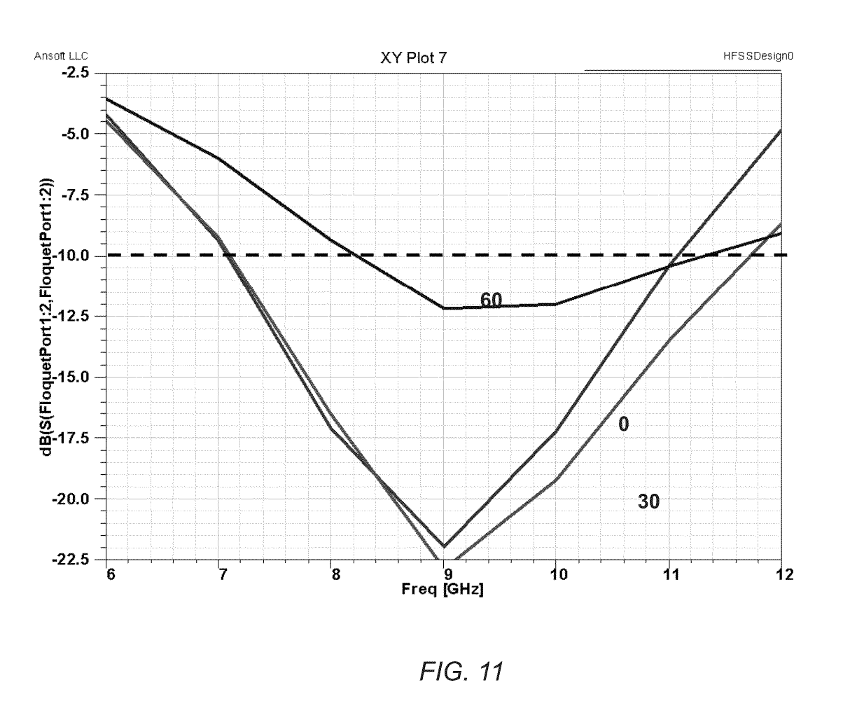

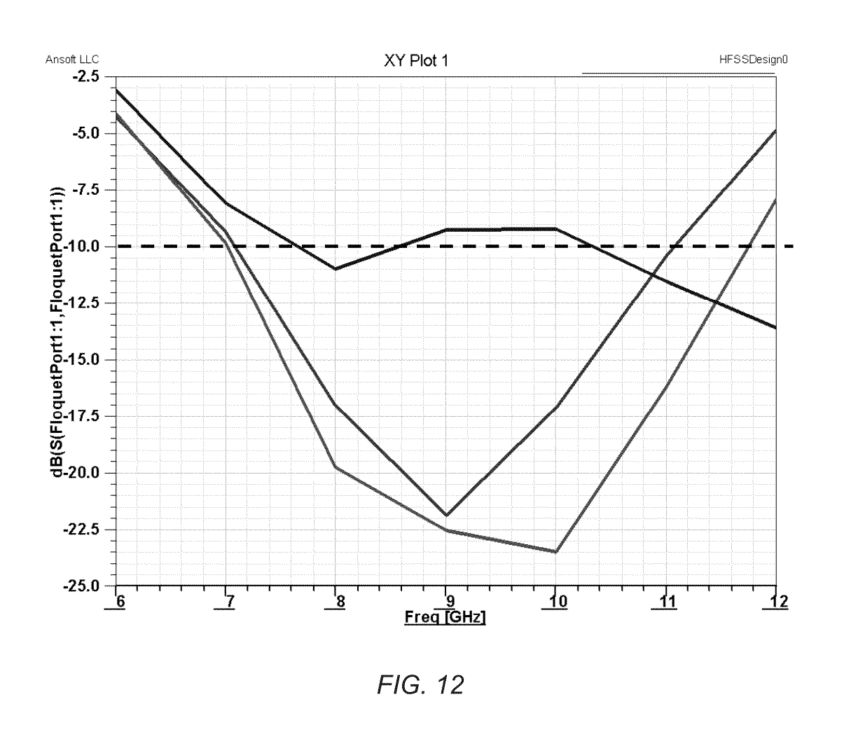

Referring to FIG. 10 and FIG. 11, return loss curves illustrate the return loss for an embodiment of a crossed-dipole antenna array, with antenna elements constructed according to the techniques described herein and corresponding generally to the embodiment illustrated in FIG. 5A and FIG. 5B. In particular, the array includes crossed-dipole elements, with S_{E}=S_{H}=0.5 inches, and H=0.3 inches. Referring to FIG. 10, the return loss curve represents that portion of power directed into one of the dipole antennas of the crossed-dipole antenna element 400 (FIG. 5A) that is reflected back from the antenna element, as determined at an input to the transmission line. A return loss of −10 dB reference line (i.e., 10 percent reflected power) generally indicates an example of an acceptable return loss at the input. Return loss curves are illustrated for various antenna array scan angles 0, 30 and 60 degrees on the E-plane of that dipole. FIG. 11 illustrates return loss for the same one of the dipole antennas of the crossed-dipole antenna element when scanning on the H-plane of that dipole. FIG. 12 illustrates return loss for the same one of the dipole antennas of the crossed-dipole antenna element when scanning on the diagonal-plane (i.e., midway between the E- and H-planes) of that dipole.

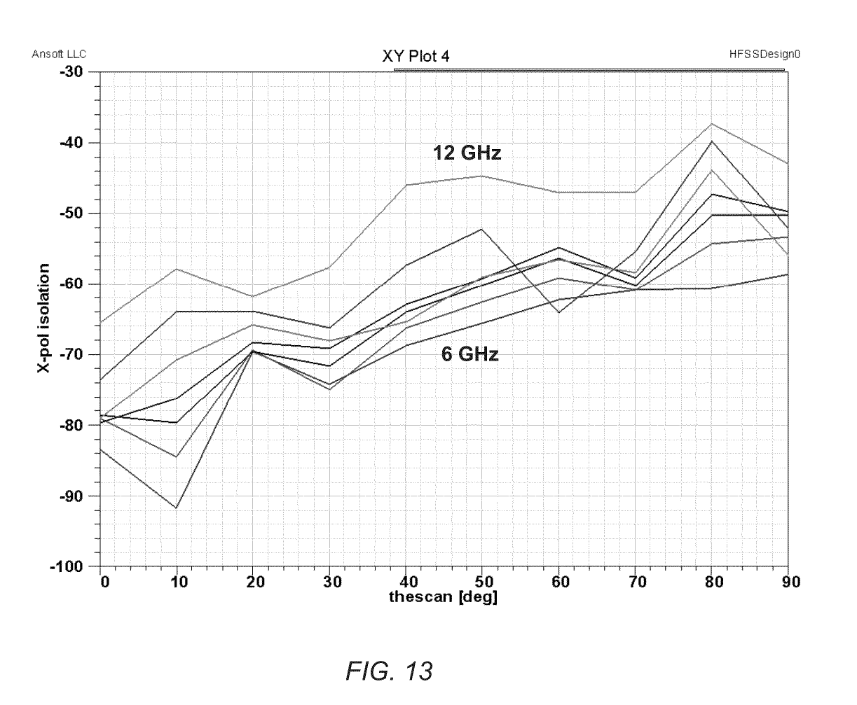

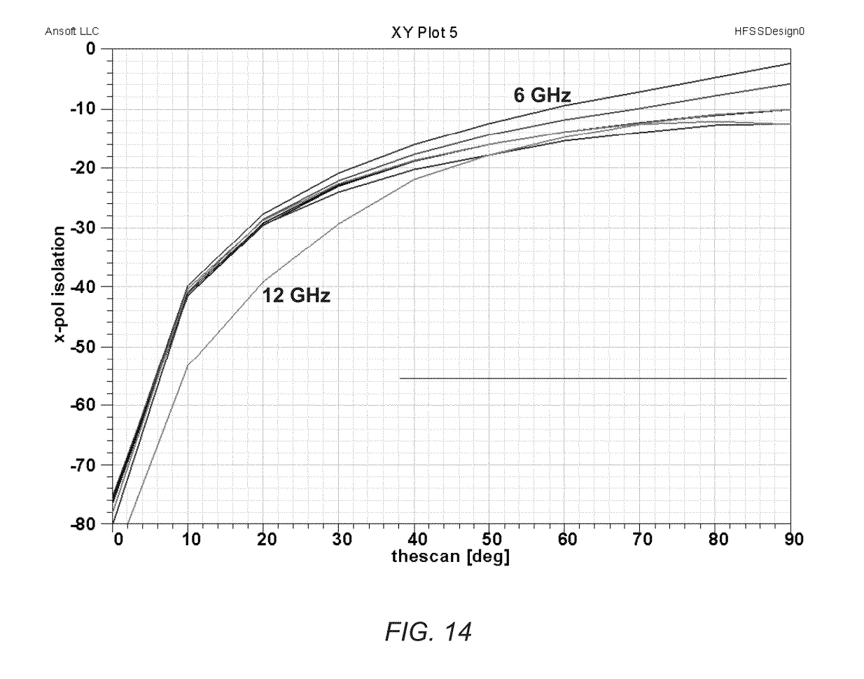

Shown in FIG. 13, is a graphical representation of cross polarization isolation between dipole antennas of the cross-polarized radiating element assembly 400 (FIG. 5) of the illustrative crossed-dipole array. In particular, electromagnetic energy is injected into one of the dipole antenna elements 404a and return energy is measured from the other dipole antenna element 404b. The model was repeated, calculating the cross-polarization coupling between elements for various frequencies from 6 to 12 GHz. The frequency results are reflected parametrically by the individual curves, with each curve covering a range of antenna scan angles from 0 to 90 degrees. The angles represent elevation angles in either the E- or H-plane of one dipole antenna of the cross-dipoles. FIG. 14 represents similar cross-polarization isolation results determined for the same cross-polarized radiating element assembly 400 in an array operated over the same frequency ranges, but with scan angles from 0 to 90 degrees, reflecting array scanning in the diagonal plane.

Any of the antenna assemblies described herein can be fabricated as integrated circuits having one or more electrically conductive layers (e.g., traces and ground planes) separated from each other by one or more insulting layers. Such circuits can be formed on a dielectric substrate, such as Silicon, Germanium, III-V materials, such as Gallium-Arsenide (GaAs), and combinations of such dielectrics. Alternatively or in addition, any of the antenna assemblies described herein can be fabricated as printed circuit boards having one or more electrically conductive layers (e.g., traces and ground planes) separated from each other by one or more insulting layers.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. An antenna array comprising:
a first ground plane extending between lower and upper edges;
a first antenna positioned above the upper edge of the first ground plane;
a second ground plane also extending between respective lower and upper edges, the second ground plane disposed substantially parallel to the first ground plane, such that the first and second ground planes define an overlapping region, the ground planes spaced apart by a separation distance; and
a second antenna positioned above the upper edge of the second ground plane,
wherein the arrangement of first and second ground planes rejects electromagnetic coupling into the overlapping area between the first and second ground planes.

2. The antenna array of claim 1, wherein the separation distance is less than about one-half a shortest anticipated wavelength of operation.

3. The antenna array of claim 1, wherein at least one of the first and second antennas is a dipole antenna.

4. The antenna array of claim 1, wherein each of the first and second dipole antennas is defined by a conducting region on an insulating substrate, and each respective one of the first and second ground planes is also defined by a conducting region on the insulating substrate.

5. The antenna array of claim 4, wherein the substrate comprises a structural support.

6. The antenna array of claim 1, further comprising a reference ground plane in electrical contact with the respective lower edge of each of the first and second ground planes, the reference ground plane also being positioned perpendicular to each of the first and second ground planes.

7. The antenna array of claim 6, further comprising respective transmission lines, each extending between a feed point of a respective one of the first and second dipole antennas and a respective dipole antenna interface port disposed on an opposite side of the reference ground plane.

8. The antenna array of claim 1, wherein a distance between the lower and upper edges of each of the first and second ground planes is substantially equivalent.

9. The antenna array of claim 1, further comprising:
a third ground plane extending between lower and upper edges and intersecting each of the first and second ground planes at an intersection angle; and
a third antenna disposed at a height above the upper edge of the third ground plane, the third antenna having a different polarization than either of the first and second antennas.

10. The antenna array of claim 9, wherein at least one of the first, second and third antennas is a dipole antenna.

11. The antenna array of claim 9, wherein each of the first, second and third antennas is defined by a respective conducting region on a respective insulating substrate, and each respective one of the first, second and third ground planes is also defined by a conducting region on a respective one of the insulating substrates.

12. The antenna array of claim 9, further comprising a reference ground plane in electrical contact with the respective lower edge of each of the first, second and third ground planes, the reference ground plane also positioned perpendicular to each of the first, second and third ground planes.

13. The antenna array of claim 9, wherein the intersection angle is approximately 90 degrees.

14. The antenna array of claim 1, wherein a distance between the lower and upper edges of each of the first and second ground planes is substantially equivalent.

15. The antenna array of claim 1, wherein each of the first and second ground planes and the orthogonal ground plane are configured for interlocking engagement.

16. The antenna array of claim 1, further comprising at least one phase offset in electrical communication with at least one antenna interface port, the phase offsets adapted to steer a radiation pattern of the antenna array.

17. An antenna array element comprising:
a first ground plane extending between lower and upper edges;
a first radiating element having a respective phase center, the first radiating element positioned above the upper edge of the first ground plane, the first radiating element having a first associated polarization;
a second ground plane also extending between respective lower and upper edges, the second ground plane disposed substantially orthogonal to the first ground plane; and
a second radiating element having a respective phase center, the second radiating element positioned above the upper edge of the second ground plane, the second radiating element having a second associated polarization, different from the first,
wherein the respective phase centers of the first and second radiating elements are coincident.

18. The antenna array element of claim 17, further comprising an electrically conducting backplane abutting bottom edges of the first and second ground planes, wherein the backplane is substantially isolated from the first and second radiating elements when configured in rectangular arrays of similar array elements.

19. The antenna array element of claim 18, wherein the radiating elements are dipole antennas.

20. The antenna array element of claim 19, wherein a polarization angle between dipole antennas is substantially 90 degrees.
